(19) United States
(12) Patent Application Publication
(10) Pub. No.: US 2017/0127026 A1
(43) Pub. Date: May 4, 2017

(54) PROJECTOR AND WAVELENGTH CONVERSION DEVICE

(71) Applicant: Coretronic Corporation, Hsin-Chu (TW)

(72) Inventor: Pi-Tsung Hsu, Hsin-Chu (TW)

(21) Appl. No.: 15/263,118

(22) Filed: Sep. 12, 2016

(30) Foreign Application Priority Data
Oct. 30, 2015 (TW) 104135878

(51) Int. Cl. H04N 9/31; G02B 26/00; G03B 21/20

(52) U.S. Cl. CPC H04N 9/3111; G03B 21/204; G02B 26/008

(57) ABSTRACT

A projector includes an illumination system having light source device and wavelength conversion device. The light source device provides a first beam. The wavelength conversion device includes wavelength conversion element, light transmissive element, and weighting structure. The wavelength conversion element includes substrate, at least one wavelength conversion region, and through slot. The at least one wavelength conversion region is disposed on the substrate and converts a portion of the first beam into a second beam. The light transmissive element is disposed at the through slot to form a light transmissive region. The remaining portion of the first beam passes through the light transmissive region, and an illumination light beam is constituted by the second beam and the remaining portion of the first beam. The weighting structure is connected to the substrate and has a first joint surface, and the first joint surface and the light transmissive element are jointed.

### FIELD OF THE INVENTION

The invention relates to a projector, and more particularly to a projector having a wavelength conversion device.

### BACKGROUND OF THE INVENTION

In the present laser projection device, pure light source required by projector is generated by stimulating phosphor with beam emitted from laser diode with qualified efficiency. Typically, the phosphor is coated on a substrate to form a phosphor wheel, and then the phosphor on the substrate is stimulated by the laser beam emitted from the laser light source to generate lights with different colors. Further, the laser beam may also directly pass through the phosphor wheel via the hollow slot of the substrate. The phosphor wheel may rotate by a driving of a drive motor, so that the phosphor coated on the substrate and representing different color regions correspond to the laser beam emitted from the laser light source thereby generating the corresponding light.

While being driven by the drive motor, the phosphor wheel may have a high-speed rotation; and therefore, if the dynamic balance of the phosphor wheel is not guaranteed, a loud noise may generated, the quality of the product may be affected and even the phosphor wheel may have damage. In addition, the phosphor wheel generally has insufficient assembly strength; therefore, the phosphor wheel may have a detachment while in high-speed rotation. Thus, it is quite import to solve the aforementioned problems.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

One object of the invention is to provide a projector having a wavelength conversion device. The wavelength conversion device includes a weighting structure to guarantee a dynamic balance while the wavelength conversion device is in high-speed rotation. Further, through the weighting structure, the adhering area for assembling the components of the projector is increased and the reliability of the structure(s) of the projector is increased.

Another object of the invention is to provide an illumination system having a wavelength conversion device. The wavelength conversion device includes a weighting structure to guarantee a dynamic balance while the wavelength conversion device is in high-speed rotation. Further, through the weighting structure, the adhering area for assembling the components of the projector is increased and the reliability of the structure(s) of the projector is increased.

Other objects and advantages of the invention can be further illustrated by the technical features broadly embodied and described as follows.

In order to achieve one or a portion of or all of the objects or other objects, the invention provides a projector including an illumination system, a light valve, and a lens. The illumination system includes a light source device and a wavelength conversion device. The light source device is adapted to provide a first light beam. The wavelength conversion device is disposed on a transmission path of the first light beam. The wavelength conversion device includes a wavelength conversion element, a light transmissive element, and a weighting structure. The wavelength conversion element has a substrate, at least one wavelength conversion region, and a through slot. The at least one wavelength conversion region is disposed on the substrate, and adapted to convert a portion of the first light beam into a second light beam. The light transmissive element is disposed at the through slot to form a light transmissive region adjacent to the at least one wavelength conversion region. The remaining portion of the first light beam is adapted to pass through the light transmissive region, and an illumination light beam is constituted by the second light beam and the remaining portion of the first light beam. The weighting structure is connected to the substrate, and has a first joint surface. The first joint surface of the weighting structure and the light transmissive element are jointed. The light valve is disposed on a transmission path of the illumination light beam, and adapted to convert the illumination light beam into an image light beam. The lens is disposed on a transmission path of the image light beam, and adapted to convert the image light beam into a projection light beam.

In order to achieve one or a portion of or all of the objects or other objects, the invention further provides a wavelength conversion device including a wavelength conversion element, a light transmissive element, and a weighting structure. The wavelength conversion element has a substrate, at least one wavelength conversion region, and a through slot. The at least one wavelength conversion region is disposed on the substrate. The light transmissive element is disposed at the through slot to form a light transmissive region adjacent to the at least one wavelength conversion region. The weighting structure is connected to the substrate, and has a first joint surface. The first joint surface of the weighting structure and the light transmissive element are jointed.

In one embodiment of the projector and the wavelength conversion device, the substrate of the wavelength conversion element has a first surface, a second surface opposite to the first surface, and an inner wall surface adjacent to the through slot. The at least one wavelength conversion region is disposed on the first surface. The weighting structure is disposed on the second surface. The first joint surface faces the through slot. The inner wall surface is disposed between the first surface and the first joint surface. The light transmissive element leans against the inner wall surface.

In one embodiment of the projector and the wavelength conversion device, the substrate of the wavelength conversion element has a first surface, a second surface opposite to the first surface, and an inner wall surface adjacent to the through slot. The at least one wavelength conversion region is disposed on the first surface. The weighting structure is disposed on the first surface. The first joint surface faces the through slot. The inner wall surface is disposed between the second surface and the first joint surface. The light transmissive element leans against the inner wall surface.

In one embodiment of the projector and the wavelength conversion device, the substrate of the wavelength conversion element has a first surface and a second surface opposite to the first surface. The at least one wavelength conversion region is disposed on the first surface. The weighting structure has a third surface opposite to the first joint surface. The first joint surface and the first surface are coplanar. The third surface and the second surface are coplanar.

In one embodiment of the projector and the wavelength conversion device, the substrate of the wavelength conversion element has a first surface and a second surface opposite to the first surface. The at least one wavelength conversion region is disposed on the first surface. The weighting structure has a third surface opposite to the first joint surface. The first joint surface and the second surface are coplanar. The third surface and the first surface are coplanar.

In one embodiment of the projector and the wavelength conversion device, the wavelength conversion device further includes a first adhesive layer disposed between the weighting structure and the light transmissive element. Through the first adhesive layer, the light transmissive element is adhered to the weighting structure.

In one embodiment of the projector and the wavelength conversion device, the substrate of the wavelength conversion element has a first surface and a second surface opposite to the first surface. The at least one wavelength conversion region is disposed on the first surface. The wavelength conversion device further includes an annular body and a second adhesive layer. The annular body is disposed on the first surface. A part of the light transmissive element is covered by the annular body. The second adhesive layer is disposed between the annular body and the wavelength conversion element, and disposed between the annular body and the light transmissive element. Through the second adhesive layer, the annular body is adhered to the wavelength conversion element and the light transmissive element.

In one embodiment of the projector and the wavelength conversion device, the annular body has a main body and a first slot structure. The first slot structure is annularly disposed at the main body.

In one embodiment of the projector and the wavelength conversion device, the wavelength conversion device further includes a weighting material disposed on the annular body. The annular body has a first slot structure located between the weighting material and the wavelength conversion element.

In one embodiment of the projector and the wavelength conversion device, the wavelength conversion device further includes a drive motor and a third adhesive layer. The drive motor has a rotating axis and a second joint surface. The second joint surface and the second surface of the substrate are jointed. The wavelength conversion element and the annular body are adapted to rotate around the rotating axis. The third adhesive layer is disposed between the second joint surface and the second surface. Through the third adhesive layer, the drive motor is adhered to the wavelength conversion element.

In one embodiment of the projector and the wavelength conversion device, the wavelength conversion element has a second slot structure disposed on the substrate. The second slot structure is located between the annular body and the at least one wavelength conversion region and also between the weighting structure and the at least one wavelength conversion region.

In one embodiment of the projector and the wavelength conversion device, the substrate of the wavelength conversion element has a first inner wall surface and a second inner wall surface. The first inner wall surface and the second inner wall surface are adjacent to the through slot and face each other. An angle is formed between the first inner wall surface and the second inner wall surface. When the angle is a first angle, the weighting structure is connected to a first position of the through slot. When the angle is a second angle, the weighting structure is connected to a second position of the through slot. When the first angle is smaller than the second angle, a distance between the first position and a center point of the wavelength conversion element is smaller than a distance between the second position and the center point of the wavelength conversion element.

In one embodiment of the projector and the wavelength conversion device, when a density of the weighting structure has a first density value, the weighting structure is connected to a first position of the through slot. When the density of the weighting structure has a second density value, the weighting structure is connected to a second position of the through slot. When the first density value is greater than the second density value, a distance between the first position and a center point of the wavelength conversion element is smaller than a distance between the second position and the center point of the wavelength conversion element.

In summary, through designing the wavelength conversion device of the projector of the embodiment of the invention to be equipped with the weighting structure connected to the substrate of the wavelength conversion element and having the first joint surface jointed/engaged with the light transmissive element, not only the dynamic balance is guaranteed while the wavelength conversion device is in high-speed rotation but also an additional adhering area between the light transmissive element and the wavelength conversion element is further increased, so that the light transmissive element may be assembled to the wavelength conversion element firmly. Therefore, while the wavelength conversion device is in high-speed rotation, the light transmissive element detaching from the through slot of the wavelength conversion element is avoided and the reliability of the overall structure of the projector is further improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a projector in accordance with an embodiment of the invention;

FIG. 2 is a schematic exploded view diagram of a wavelength conversion device in accordance with an embodiment of the invention;

FIG. 3 is a schematic top view diagram of the assembled wavelength conversion device of FIG. 2;

FIG. 4 is a schematic bottom view diagram of the assembled wavelength conversion device of FIG. 2;

FIGS. 5A and 5B are schematic views of the disposing positions of the weighting structure in accordance with an embodiment of the invention;

FIGS. 6A and 6B are schematic views of the disposing positions of the weighting structure in accordance with another embodiment of the invention;

FIG. 7 is a schematic exploded view of a wavelength conversion device in accordance with another embodiment of the invention;

FIG. 8 is a schematic top view of the assembled wavelength conversion device of FIG. 7;

FIG. 9 is a schematic bottom view of the assembled wavelength conversion device of FIG. 7;

FIG. 10 is a schematic cross-sectional view of a wavelength conversion device in accordance with another embodiment of the invention;

FIG. 11 is a schematic cross-sectional view of a wavelength conversion device in accordance with another embodiment of the invention;

FIG. 12 is a schematic cross-sectional view of a wavelength conversion device in accordance with another embodiment of the invention;

FIG. 13A is a schematic top view of a wavelength conversion device in accordance with another embodiment of the invention; and

FIG. 13B is a schematic cross-sectional view taken along the line E-E in FIG. 13A.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

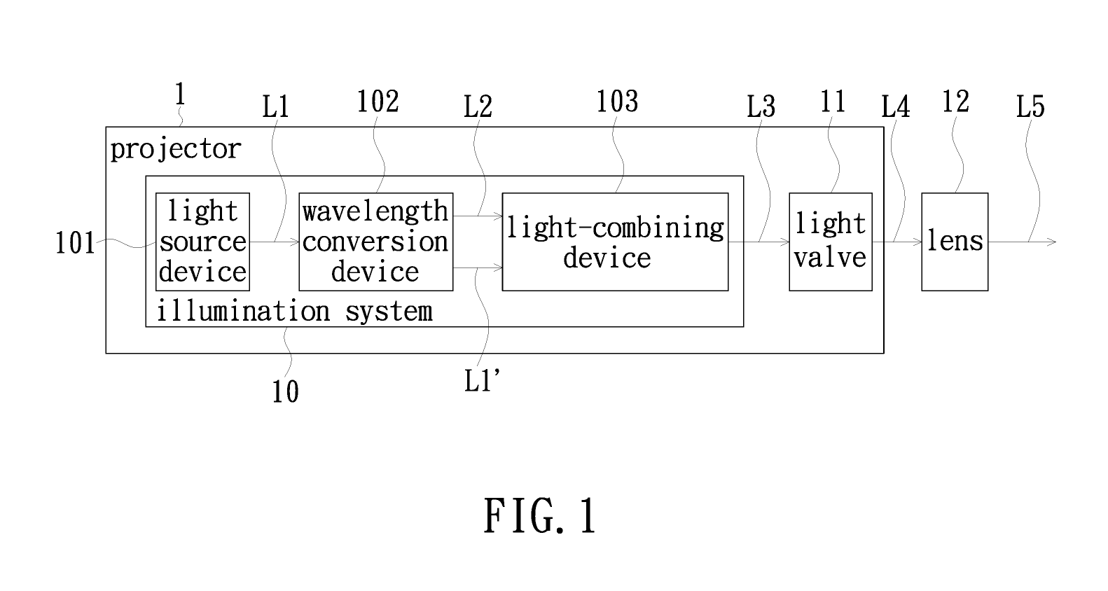

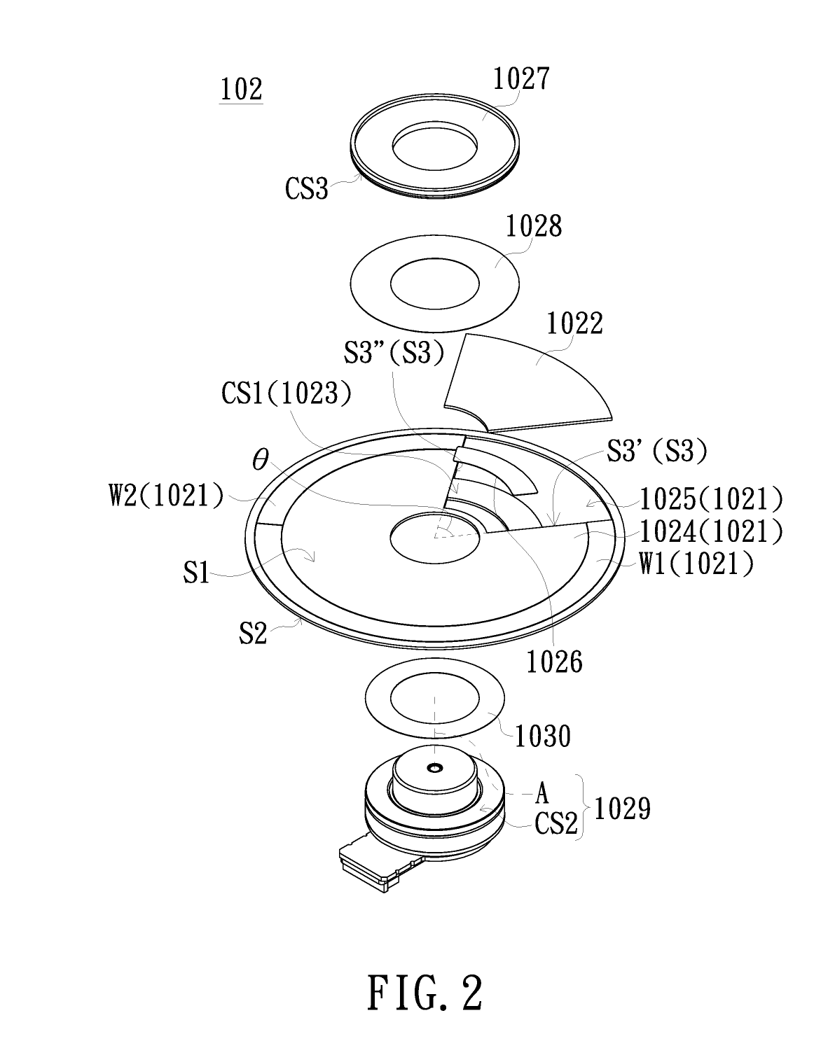

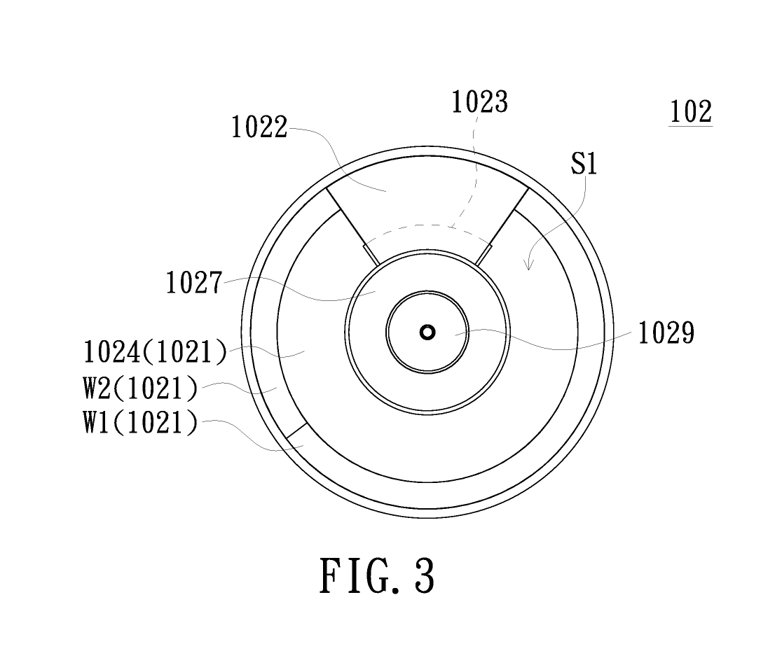

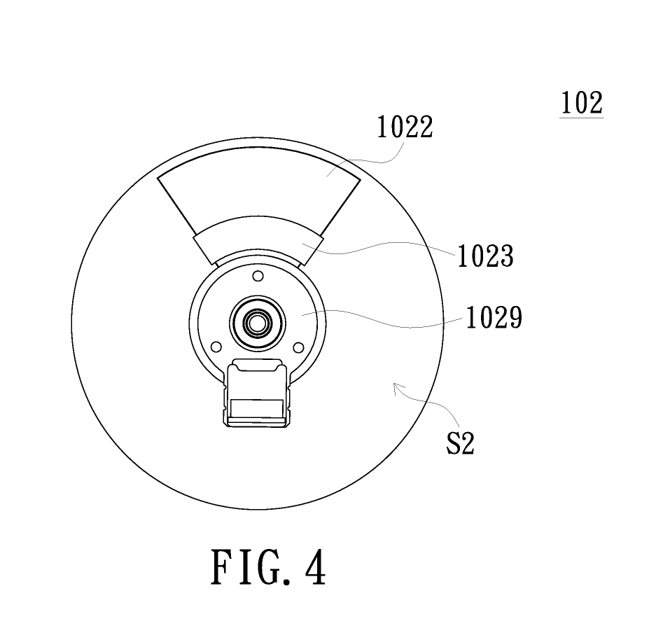

FIG. 1 is a functional block diagram of a projector in accordance with an embodiment of the invention. FIG. 2 is a schematic exploded view diagram of a wavelength conversion device in accordance with an embodiment of the invention. FIG. 3 is a schematic top view diagram of the assembled wavelength conversion device of FIG. 2. FIG. 4 is a schematic bottom view diagram of the assembled wavelength conversion device of FIG. 2. As shown in FIGS. 1-4, the projector 1 of the embodiment includes an illumination system 10, a light valve 11, and a lens 12. In the embodiment, the illumination system 10 includes a light source device 101, a wavelength conversion device 102, and a light-combining device 103. In the embodiment, the light valve 11 may be a digital micro mirror device (DMD), a liquid crystal on silicon, (LCoS) or a liquid crystal display (LCD), but the invention is not limited thereto.

Please continue to refer to FIGS. 1-4. In the embodiment, the light source device 101 is adapted to provide a first light beam L1. The wavelength conversion device 102 is disposed on the transmission path of the first light beam L1. The wavelength conversion device 102 includes a wavelength conversion element 1021, a light transmissive element 1022, and a weighting structure 1023. The wavelength conversion element 1021 includes a substrate 1024, at least one wavelength conversion region (the detail will be described below), and a through slot 1025. The substrate 1024 may be, for example, a disc-shaped metal substrate in the embodiment; the substrate 1024 may be a light transmissive substrate in other embodiments; but the invention is not limited thereto. The at least one wavelength conversion region is disposed on the substrate 1024, and the at least one wavelength conversion region is adapted to convert a portion of the first light beam L1 into a second light beam L2.

In the embodiment, to be more specific, the wavelength conversion element 1021 includes wavelength conversion regions W1 and W2, but the invention is not limited thereto. The wavelength conversion regions W1 and W2 may be respectively coated with phosphor having different colors, and may be respectively configured to convert a portion of the first light beam L1 into colored lights (the second light beam L2) having different wavelengths. The aforementioned description about the wavelength conversion region W1 and wavelength conversion region W2 is an example, and the number of the wavelength conversion region and the method of the beam conversion are not limited in the invention. In the embodiment, the light transmissive element 1022 is disposed at the through slot 1025 to form a light transmissive region adjacent to the wavelength conversion regions W1 and W2. The remaining portion of the first light beam L1′ is adapted to pass through the light transmissive region. In the embodiment, the second light beam L2 is converted from the wavelength conversion regions W1, W2, and the first light beam L1′ passes through the light transmissive region. In the embodiment, an illumination light beam L3 is constituted by the second light beam L2 and the first light beam L1′ through, for example, the light-combining device 103. The light valve 11 is disposed on the transmission path of the illumination light beam L3, and adapted to convert the illumination light beam L3 into an image light beam L4. The lens 12 is disposed on the transmission path of the image light beam L4, and adapted to convert the image light beam L4 into a projection light beam L5.

The material of the light transmissive element 1022 in the embodiment is, for example, glass; the material of the light transmissive element 1022 in other embodiments may be plastic; but the invention is not limited thereto. The weighting structure 1023 is connected to the substrate 1024 and has a first joint surface CS1. The first joint surface CS1 of the weighting structure 1023 and the light transmissive element 1022 are jointed.

The detailed stricture of the wavelength conversion device 102 of the embodiment will be described in the following.

As shown in FIGS. 2-4, the substrate 1024 of the wavelength conversion element 1021 of the wavelength conversion device 102 of the embodiment has a first surface S1, a second surface S2 opposite to the first surface S1, and an inner wall surface S3 adjacent to the through slot 1025. In the embodiment, the wavelength conversion regions W1 and W2 are disposed on the first surface S1 of the substrate 1024. In the embodiment, the weighting structure 1023 is disposed on and connected to the second surface S2 of the substrate 1024. The first joint surface CS1 of the weighting structure 1023 faces the through slot 1025; and the inner wall surface S3 is disposed between the first surface S1 and the first joint surface CS1 of the weighting structure 1023. In the embodiment, the light transmissive element 1022 leans against the inner wall surface S3. To be more specific, the two ends of the first joint surface CS1 of the weighting structure 1023 are respectively connected to the boundaries between the inner wall surface S3 and the second surface S2 of the substrate 1024; therefore, a stair structure may be formed through the first joint surface CS1 of the weighting structure 1023 and the inner wall surface S3. Trough the stair structure design, the joint area where the light transmissive element 1022 and the substrate 1024 are jointed/engaged with each other is increased. Namely, the light transmissive element 1022 is also jointed/engaged with the first joint surface CS1 of the weighting structure 1023 besides being jointed/engaged with the inner wall surface S3, and therefore the light transmissive element 1022 may be jointed/engaged with the substrate 1024 more securely/stably/firmly.

In the embodiment, the weighting structure 1023 is, for example, a structure formed by a part of substrate 1024 which is reserved when the substrate 1024 is stamped/punched to form the through slot 1025; namely, the weighting structure 1023 and the substrate 1024 may, for example, have an integrated/integrally-formed/one-piece structure, but the invention is not limited thereto. In other embodiments, the weighting structure 1023 is, for example, an individual member separated from the substrate 1024 before the weighting structure 1023 and the substrate 1024 are jointed/engaged. After the first joint surface CS1 of the weighting structure 1023 is jointed/engaged with the second surface S2 of the substrate 1024, the stair structure is formed with the first joint surface CS1a nd the inner wall surface S3.

As shown in FIG. 2, the wavelength conversion device 102 of the embodiment further includes a first adhesive layer 1026, an annular body 1027, and a second adhesive layer 1028. In the embodiment, through the stair structure formed by the first joint surface CS1 of the weighting structure 1023 and the inner wall surface S3 of the through slot 1025, the surface of the light transmissive element 1022 facing the annular body 1027 and the first surface S1 of the substrate 1024 are coplanar. In the embodiment, the first adhesive layer 1026 is disposed between the weighting structure 1023 and the light transmissive element 1022. Through the first adhesive layer 1026, the light transmissive element 1022 is adhered to the weighting structure 1023. To be more specific, the first adhesive layer 1026 may be, for example, coated on the first joint surface CS1 of the weighting structure 1023. Namely, in the embodiment, the coating area of the first adhesive layer 1026 may be substantially equal to the area of the first joint surface CS1, so that the light transmissive element 1022 and the weighting structure 1023 may be adhered to each other more securely; but the invention is not limited thereto. In the embodiment, the annular body 1027 is disposed on the first surface S1 of the substrate 1024; a part of the light transmissive element 1022 is covered by the annular body 1027; and the light transmissive element 1022 is disposed between the weighting structure 1023 and the annular body 1027. In the embodiment, the material of the annular body 1027 is metal, but the invention is not limited thereto. In the embodiment, the second adhesive layer 1028 is disposed between the annular body 1027 and the wavelength conversion element 1021 and also between the annular body 1027 and the light transmissive element 1022. Through the second adhesive layer 1028, the annular body 1027 is adhered to the substrate 1024 of the wavelength conversion element 1021 and the light transmissive element 1022. To be more specific, the second adhesive layer 1028 is coated on the joint surface CS3 where the annular body 1027 and the wavelength conversion element 1021/the light transmissive element 1022 are jointed/engaged. Namely, in the embodiment, the coating area of the second adhesive layer 1028 may be substantially equal to the area of the joint surface CS3, so that the annular body 1027 may be adhered to the wavelength conversion element 1021 and the light transmissive element 1022 stably/firmly/securely; but the invention is not limited thereto.

As shown in FIG. 2, the wavelength conversion device 102 of the embodiment further includes a drive motor 1029 and a third adhesive layer 1030. In the embodiment, the drive motor 1029 has a rotating axis A and a second joint surface CS2. In the embodiment, the second joint surface CS2 of the drive motor is jointed/engaged with the second surface S2 of the substrate 1024; and the wavelength conversion element 1021 and the annular body 1027 are adapted to rotate with respect to the rotating axis A as an axis (the wavelength conversion element 1021 and the annular body 1027 are adapted to rotate around the rotating axis A). In the embodiment, the third adhesive layer 1030 is disposed between the second joint surface CS2 of the drive motor 1029 and the second surface S2 of the substrate 1024. Through the third adhesive layer 1030, the drive motor 1029 is adhered to the wavelength conversion element 1021. To be more specific, the third adhesive layer 1030 is coated on the second joint surface CS2 of the drive motor 1029. Namely, in the embodiment, the coating area of the third adhesive layer 1030 may be substantially equal to the area of the second joint surface CS2, so that the drive motor 1029 may be adhered to the wavelength conversion element 1021 stably/firmly/securely; but the invention is not limited thereto.

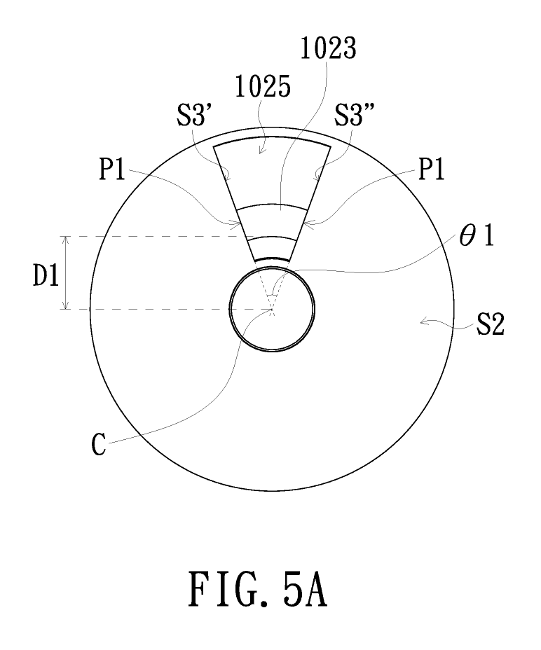

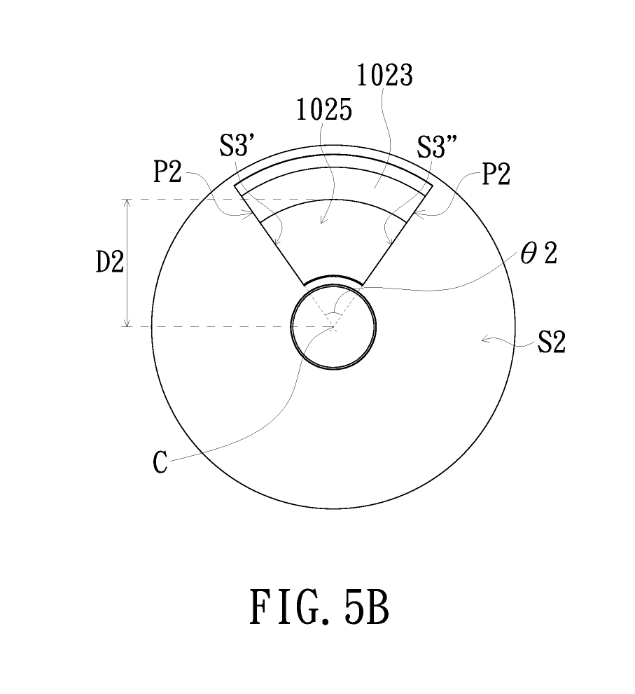

As shown in FIG. 2, the inner wall surface S3 of the wavelength conversion element 1021 of the embodiment has a first inner wall surface S3′ and a second inner wall surface S3″, and the first inner wall surface S3′ and the second inner wall surface S3″ face each other. An angle θ is formed between the first inner wall surface S3′ and the second inner wall surface S3″. As shown in FIGS. 2 and 5A, when the angle θ formed between the first inner wall surface S3′ and the second inner wall surface S3″ is a first angle θ1, the weighting structure 1023 is connected to a first position P1 of the through slot 1025. That is, the two ends of the first joint surface CS1 of the weighting structure 1023 are respectively connected to the first position P1 of the first inner wall surface S3′ and the first position P1 of the second inner wall surface S3″. As shown in FIGS. 2 and 5B, when the angle θ formed between the first inner wall surface S3′ and the second inner wall surface S3″ is a second angle θ2, the weighting structure 1023 is connected to a second position P2 of the through slot 1025. That is, the two ends of the first joint surface CS1 of the weighting structure 1023 are respectively connected to the second position P2 of the first inner wall surface S3′ and the second position P2 of the second inner wall surface S3″. In the embodiment, the first angle θ1 is smaller than the second angle θ2, and the distance D1 between the first position P1 and the center point C of the wavelength conversion element 1021 is smaller than the distance D2 between the second position P2 and the center point C of the wavelength conversion element 1021. That is, in the embodiment, when the angle θ between the first inner wall surface S3′ and the second inner wall surface S3″ is greater, the distance from the disposing position of the weighting structure 1023 to the center point C of the wavelength conversion element 1021 is farther; and when the angle θ between the first inner wall surface S3′ and the second inner wall surface S3″ is smaller, the distance from the disposing position of the weighting structure 1023 to the center point C of the wavelength conversion element 1021 is closer. From above, it is understood that the weighting effect desired to achieve in the embodiment may be realized through adjusting the position of the weighting structure 1023 and/or the angle θ between the first inner wall surface S3′ and the second inner wall surface S3″.

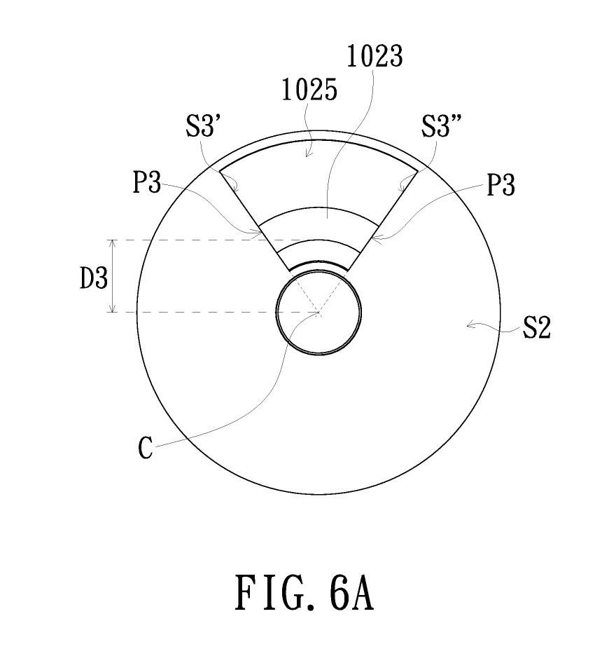

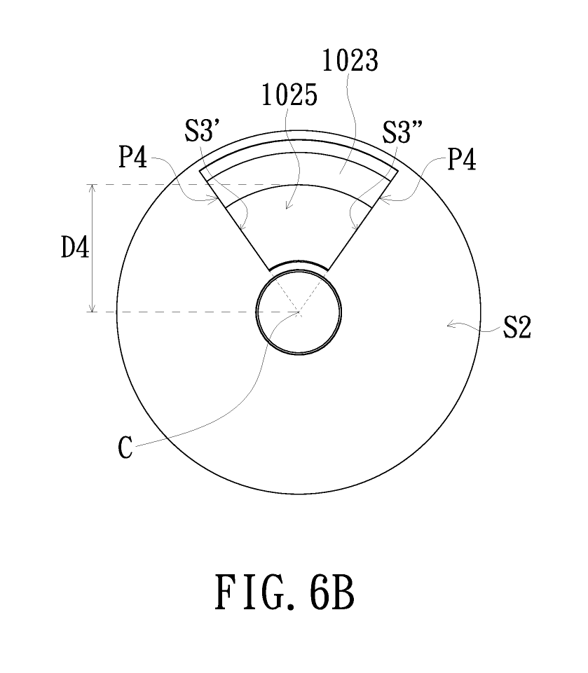

Further, in the embodiment, the disposing position of the weighting structure 1023 may vary with density of the weighting structure 1023. As shown in FIGS. 2 and 6A, when the density of the weighting structure 1023 has a first density value, the weighting structure 1023 is connected to a third position P3 of the through slot 1025. That is, the two ends of the first joint surface CS1 of the weighting structure 1023 are respectively connected to the third position P3 of the first inner wall surface S3′ and the third position P3 of the second inner wall surface S3″. As shown in FIGS. 2 and 6B, when the density of the weighting structure 1023 has a second density value, the weighting structure 1023 is connected to a fourth position P4 of the through slot 1025. That is, the two ends of the first joint surface CS1 of the weighting structure 1023 are respectively connected to the fourth position P4 of the first inner wall surface S3′ and the fourth position P4 of the second inner wall surface S3″. In the embodiment, when the first density value is greater than the second density value, the distance D3 between the third position P3 and the center point C of the wavelength conversion element 1021 is smaller than the distance D4 between the fourth position P4 and the center point C of the wavelength conversion element 1021. That is, in the embodiment, when the density of the weighting structure 1023 is greater, the distance from the disposing position of the weighting structure 1023 to the center point C of the wavelength conversion element 1021 is closer; and when the density of the weighting structure 1023 is smaller, the distance from the disposing position of the weighting structure 1023 to the center point C of the wavelength conversion element 1021 is farther. From above, it is understood that the weighting effect desired to achieve in the embodiment may be realized through adjusting the position and/or density of the weighting structure 1023.

However, it is understood that the disposing positions of the weighting structure 1023 illustrated in FIGS. 5A-6B of the four embodiments are examples; and the invention is not limited thereto. Namely, the disposing position of the weighting structure 1023 may vary in response to the actual requirements, and the disposing position of the weighting structure 1023 is selected based on not blocking the transmission path of the first light beam L1 so that the first light beam L1 may pass through the through slot 1025.

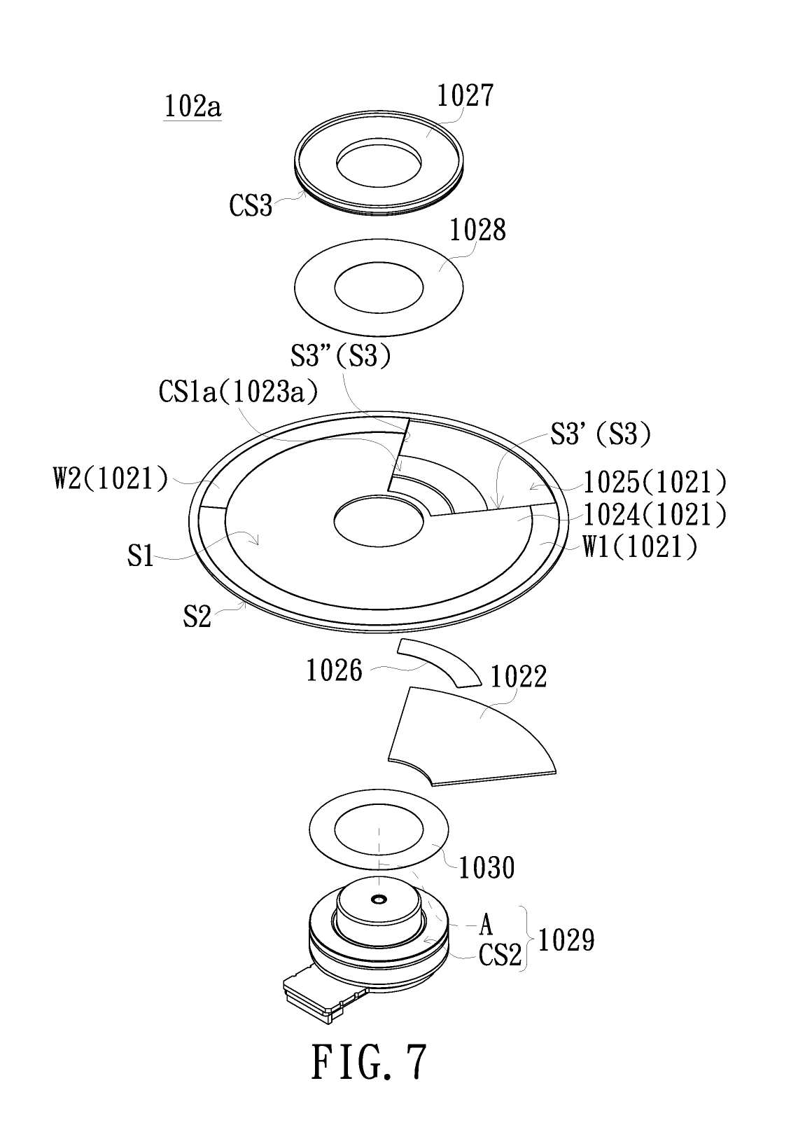

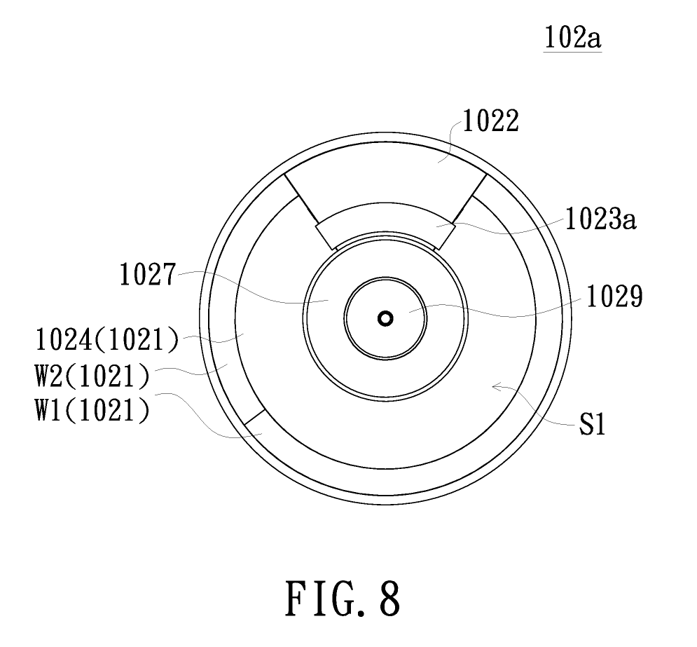

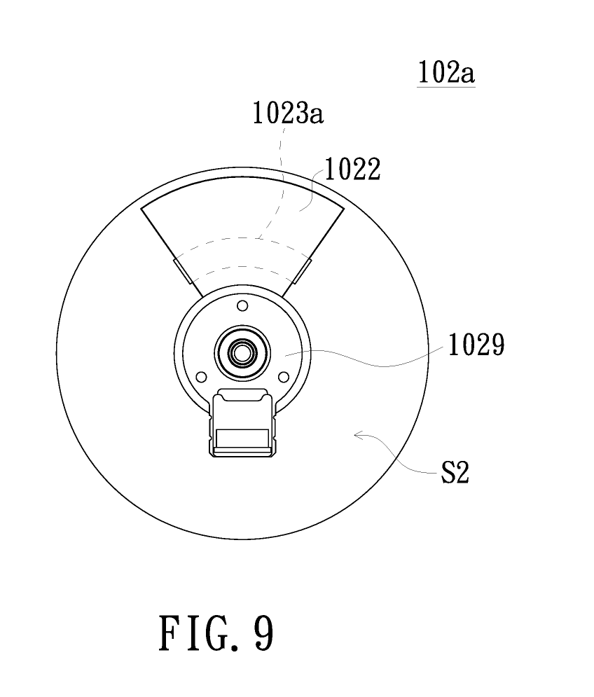

FIG. 7 is a schematic exploded view of a wavelength conversion device in accordance with another embodiment of the invention. FIG. 8 is a schematic top view of the assembled wavelength conversion device of FIG. 7. FIG. 9 is a schematic bottom view of the assembled wavelength conversion device of FIG. 7. As shown in FIGS. 7-9, the wavelength conversion device 102a of the embodiment is substantially similar to the wavelength conversion device 102 of FIGS. 2-4. A major difference lies in that the weighting structure 1023a of the wavelength conversion device 102a of the embodiment is disposed on and connected to the first surface S1 of the substrate 1024, the first joint surface CS1a of the weighting structure 1023a faces the through slot 1025, and the inner wall surface S3 is disposed between the second surface S2 of the substrate 1024 and the first joint surface CS1a of the weighting structure 1023a. In the embodiment, the two ends of the first joint surface CS1a of the weighting structure 1023a are respectively connected to the boundaries between the inner wall surface S3 and the first surface S1 of the substrate 1024, therefore a stair structure may be formed through the first joint surface CS1a of the weighting structure 1023a and the inner wall surface S3. In the embodiment, the light transmissive element 1022 leans against the inner wall surface S3, and the light transmissive element 1022 is disposed between the drive motor 1029 and the weighting structure 1023a. In the embodiment, through the stair structure formed by the first joint surface CS1a of the weighting structure 1023a and the inner wall surface S3 of the through slot 1025, the surface of the light transmissive element 1022 facing the drive motor 1029 and the second surface S2 of the substrate 1024 are coplanar.

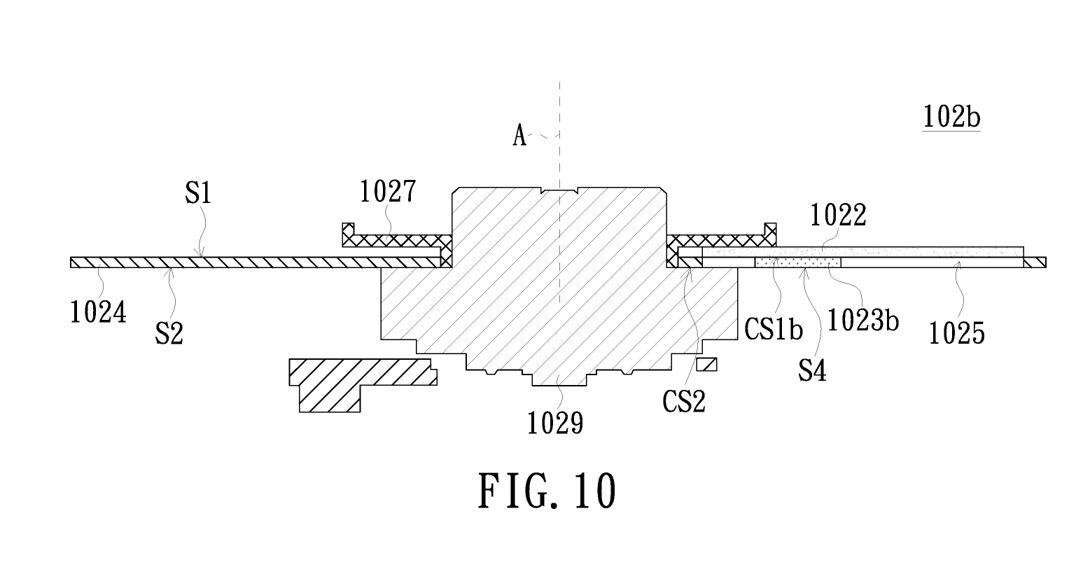

However, the aforementioned stair structure formed by the first joint surface of the weighting structure and the inner wall surface of the through slot is an example, and the invention is not limited thereto. In other embodiments, non-stair structure may be implemented. Two exemplary non-stair structures used in the embodiments will be described in the following. FIG. 10 is a schematic cross-sectional view of a wavelength conversion device in accordance with another embodiment of the invention. As shown in FIG. 10, the wavelength conversion device 102b of the embodiment is substantially similar to the wavelength conversion device 102 of FIGS. 2-4. A major difference lies in that the weighting structure 1023b of the wavelength conversion device 102b of the embodiment has a first joint surface CS1b and a third surface S4 opposite to the first joint surface CS1b. In the embodiment, the first joint surface CS1b of the weighting structure 1023b and the first surface S1 of the substrate 1024 are coplanar; and the third surface S4 of the weighting structure 1023b and the second surface S2 of the substrate 1024 are coplanar. To be more specific, in the embodiment, the weighting structure 1023b is disposed at the through slot 1025 of the wavelength conversion element 1021, and the first joint surface CS1b of the weighting structure 1023b faces the annular body 1027 (i.e., the third surface S4 of the weighting structure 1023b faces the drive motor 1029). That is, in the embodiment, when the light transmissive element 1022 is jointed/engaged with the first joint surface CS1b of the weighting structure 1023b, the light transmissive element 1022 is located above the first surface S1 of the substrate 1024 and the weighting structure 1023b; namely, the light transmissive element 1022 is located between the first surface S1 of the substrate 1024 and the annular body 1027 and also between the weighting structure 1023b and the annular body 1027.

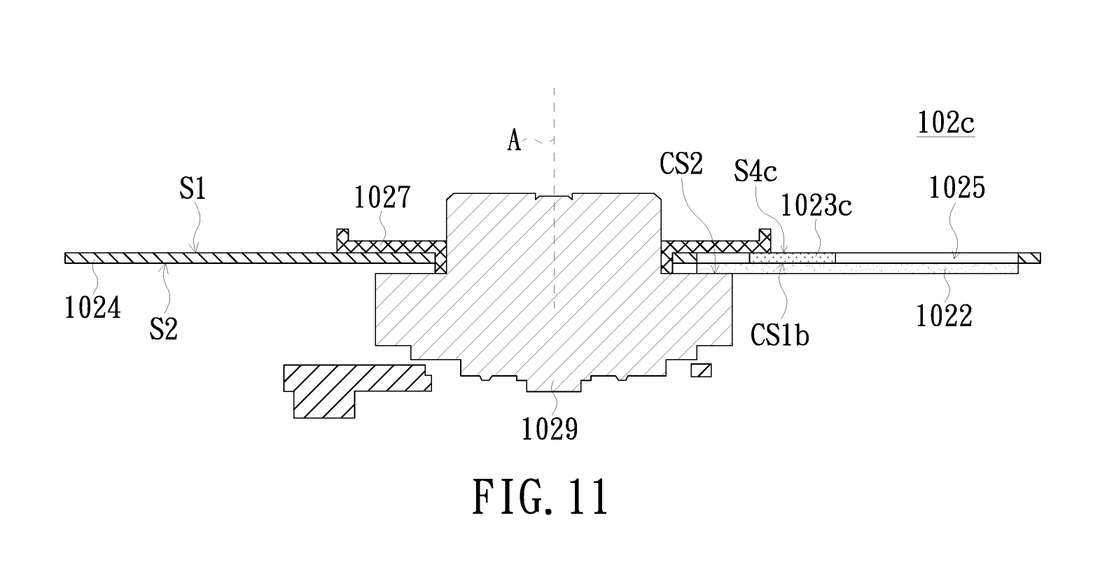

FIG. 11 is a schematic cross-sectional view of a wavelength conversion device in accordance with another embodiment of the invention. As shown in FIG. 11, the wavelength conversion device 102c of the embodiment is substantially similar to the wavelength conversion device 102b of FIG. 10. A major difference lies in that the weighting structure 1023c of the wavelength conversion device 102c of the embodiment has a first joint surface CS1b and a third surface S4c opposite to the first joint surface CS1b. In the embodiment, the first joint surface CS1b of the weighting structure 1023c and the second surface S2 of the substrate 1024 are coplanar; and the third surface S4c of the weighting structure 1023c and the first surface S1 of the substrate 1024 are coplanar. To be more specific, in the embodiment, the weighting structure 1023c is disposed at the through slot 1025 of the wavelength conversion element 1021, and the first joint surface CS1b of the weighting structure 1023c faces the drive motor 1029 (i.e., the third surface S4c of the weighting structure 1023c faces the annular body 1027). That is, in the embodiment, when the light transmissive element 1022 is jointed/engaged with the first joint surface CS1b of the weighting structure 1023c, the light transmissive element 1022 is located under the second surface S2 of the substrate 1024 and the weighting structure 1023c; namely, the light transmissive element 1022 is located between the second joint surface CS2 of the drive motor 1029 and the second surface S2 of the substrate 1024 and also between the weighting structure 1023c and the second joint surface CS2 of the drive motor 1029.

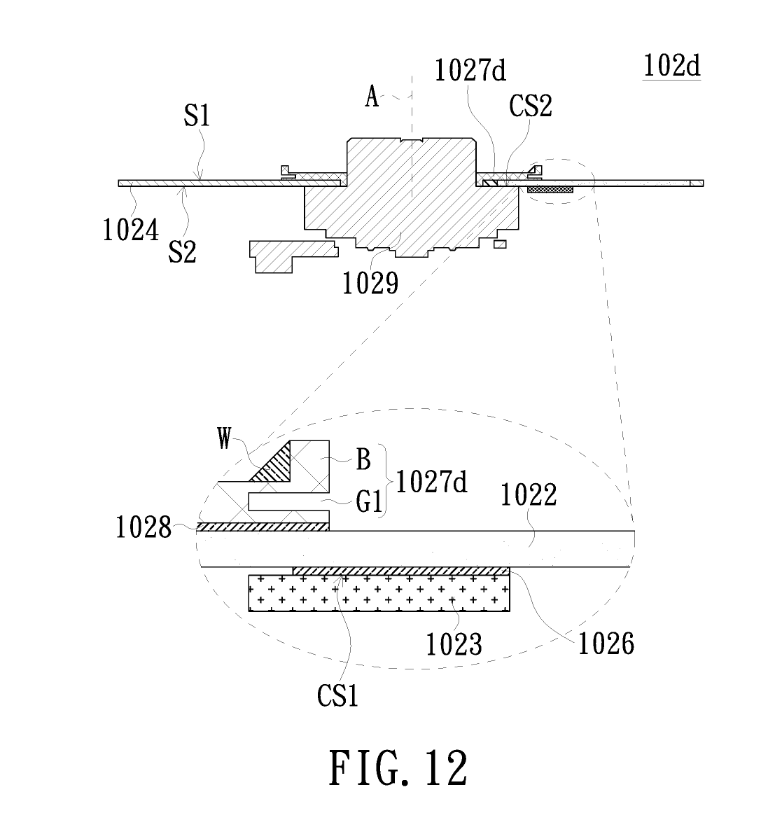

FIG. 12 is a schematic cross-sectional view of a wavelength conversion device in accordance with another embodiment of the invention. As shown in FIG. 12, the wavelength conversion device 102d of the embodiment is substantially similar to the wavelength conversion device 102 of FIGS. 2-4. A major difference lies in that the wavelength conversion device 102d of the embodiment further includes a weighting material W disposed at/on the annular body 1027d, and the annular body 1027d has a main body B and a first slot structure G1. In the embodiment, the first slot structure G1 is an annular slot annularly disposed at the main body B, located above the light transmissive element 1022 and the substrate 1024 of the wavelength conversion element, and also between the weighting material W and the light transmissive element 1022. In the embodiment, in order to achieve a more-precise weighting effect, the weighting material W may further be used for collocating with the weighting structure 1023 so that the dynamic balance is guaranteed while the wavelength conversion device 102d is in high-speed rotation. In the embodiment, the material of the weighting material W is, for example, plastic, but the invention is not limited thereto. In the embodiment, when the heat results from the wavelength conversion regions W1 and W2 being emitted by light beam (such as laser beam), the heat transmitted from the wavelength conversion regions W1 and W2 to the weighting material W may be reduced through the first slot structure G1 of the annular body 1027d annularly at in the main body B, so that the weighting material W is effectively prevented from deterioration caused by heat.

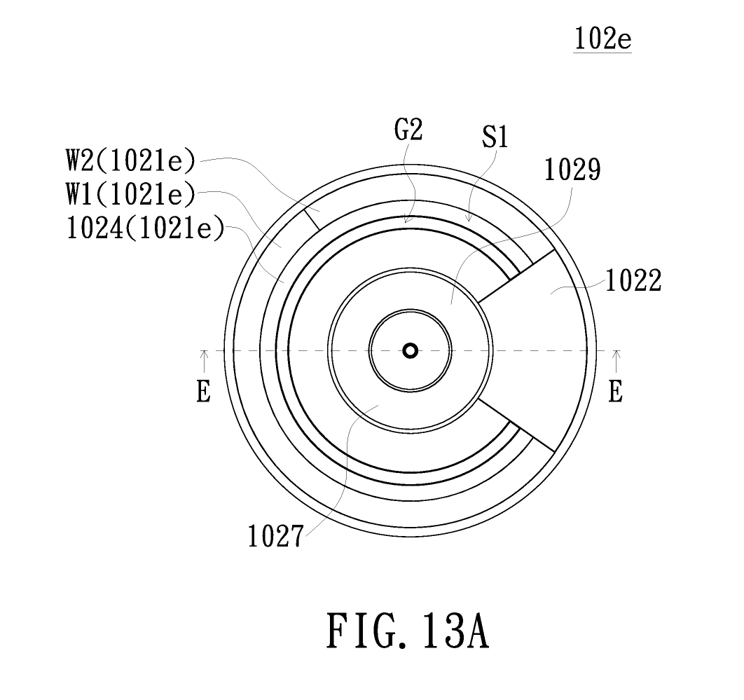

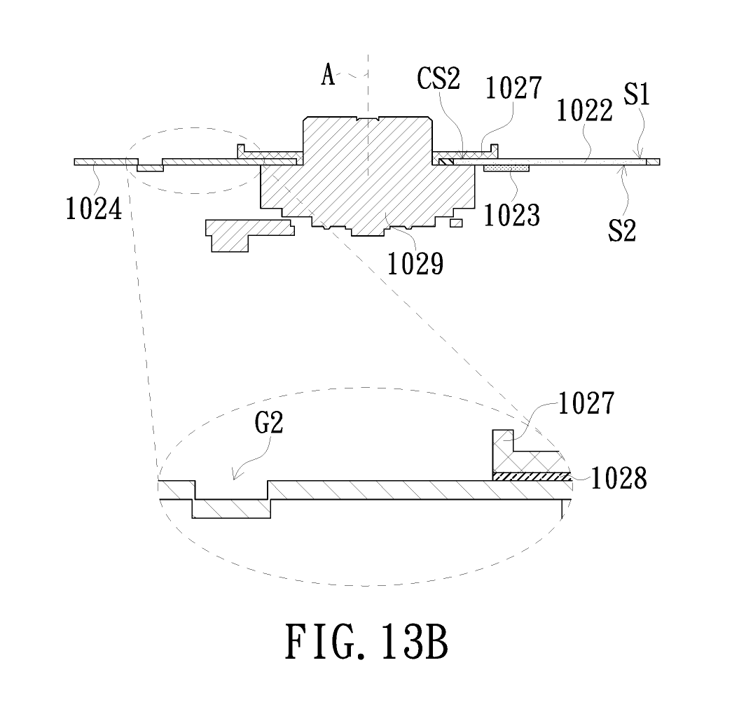

FIG. 13A is a schematic top view of a wavelength conversion device in accordance with another embodiment of the invention. FIG. 13B is a schematic cross-sectional view taken along the line E-E in FIG. 13A. As shown in FIGS. 13A and 13B, the wavelength conversion device 102e of the embodiment is substantially similar to the wavelength conversion device 102 of FIGS. 2-4. A major difference lies in that the wavelength conversion element 1021e of the wavelength conversion device 102e of the embodiment includes a second slot structure G2 disposed on the substrate 1024. In the embodiment, the second slot structure G2 is located between the annular body 1027 and the wavelength conversion regions W1, W2, and also between the weighting structure 1023 and the wavelength conversion regions W1, W2. In the embodiment, a major effect of the second slot structure G2 is: the heat transmitted from the wavelength conversion regions W1 and W2 to the adhering area (the first adhesive layer) between the light transmissive element 1022 and the weighting structure 1023, the adhering area (the second adhesive layer) between the annular body 1027 and the wavelength conversion element 1021e, and the adhering area (the third adhesive layer) between the motor drive 1029 and the wavelength conversion element 1021e may be reduced, so that the adhering areas are effectively prevented from deterioration/damage caused by heat.

In one embodiment, it is to be noted that the wavelength conversion device may have both of the first slot structure G1 in FIG. 12 and the second slot structure G2 in FIGS. 13A and 13B. Therefore, the effect of the heat dissipation is effectively enhanced.

In summary, through designing the wavelength conversion device of the projector of the embodiment of the invention to be equipped with the weighting structure connected to the substrate of the wavelength conversion element and having the first joint surface jointed/engaged with the light transmissive element, not only the dynamic balance is guaranteed while the wavelength conversion device is in high-speed rotation but also an additional adhering area between the light transmissive element and the wavelength conversion element is further increased, so that the light transmissive element may be assembled to the wavelength conversion element firmly. Therefore, while the wavelength conversion device is in high-speed rotation, the light transmissive element detaching from the through slot of the wavelength conversion element is avoided and the reliability of the overall structure of the projector is further improved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A projector, comprising:
an illumination system, comprising:
a light source device, adapted to provide a first light beam; and
a wavelength conversion device, disposed on a transmission path of the first light beam, the wavelength conversion device comprising:
a wavelength conversion element, having a substrate, at least one wavelength conversion region, and a through slot, wherein the at least one wavelength conversion region is disposed on the substrate, and the at least one wavelength conversion region is adapted to convert a portion of the first light beam into a second light beam;
a light transmissive element, disposed at the through slot to form a light transmissive region adjacent to the at least one wavelength conversion region, wherein a remaining portion of the first light beam is adapted to pass through the light transmissive region, and an illumination light beam is constituted by the second light beam and the remaining portion of the first light beam; and
a weighting structure, connected to the substrate, and having a first joint surface, wherein the first joint surface of the weighting structure and the light transmissive element are jointed;
a light valve, disposed on a transmission path of the illumination light beam, and adapted to convert the illumination light beam into an image light beam; and
a lens, disposed on a transmission path of the image light beam, and adapted to convert the image light beam into a projection light beam.

2. The projector according to claim 1, wherein the substrate of the wavelength conversion element has a first surface, a second surface opposite to the first surface, and an inner wall surface adjacent to the through slot, the at least one wavelength conversion region is disposed on the first surface, the weighting structure is disposed on the second surface, the first joint surface faces the through slot, the inner wall surface is disposed between the first surface and the first joint surface, and the light transmissive element leans against the inner wall surface.

3. The projector according to claim 1, wherein the substrate of the wavelength conversion element has a first surface, a second surface opposite to the first surface, and an inner wall surface adjacent to the through slot, the at least one wavelength conversion region is disposed on the first surface, the weighting structure is disposed on the first surface, the first joint surface faces the through slot, the inner wall surface is disposed between the second surface and the first joint surface, and the light transmissive element leans against the inner wall surface.

4. The projector according to claim 1, wherein the substrate of the wavelength conversion element has a first surface and a second surface opposite to the first surface, the at least one wavelength conversion region is disposed on the first surface, the weighting structure has a third surface opposite to the first joint surface, the first joint surface and the first surface are coplanar, and the third surface and the second surface are coplanar.

5. The projector according to claim 1, wherein the substrate of the wavelength conversion element has a first surface and a second surface opposite to the first surface, the at least one wavelength conversion region is disposed on the first surface, the weighting structure has a third surface opposite to the first joint surface, the first joint surface and the second surface are coplanar, and the third surface and the first surface are coplanar.

6. The projector according to claim 1, wherein the wavelength conversion device further comprises a first adhesive layer disposed between the weighting structure and the light transmissive element, wherein the light transmissive element is adhered to the weighting structure through the first adhesive layer.

7. The projector according to claim 1, wherein the substrate of the wavelength conversion element has a first surface and a second surface opposite to the first surface, the at least one wavelength conversion region is disposed on the first surface, the wavelength conversion device further comprises:
an annular body, disposed on the first surface, wherein a part of the light transmissive element is covered by the annular body; and
a second adhesive layer, disposed between the annular body and the wavelength conversion element, and disposed between the annular body and the light transmissive element, wherein the annular body is adhered to the wavelength conversion element and the light transmissive element through the second adhesive layer.

8. The projector according to claim 7, wherein the annular body has a main body and a first slot structure, wherein the first slot structure is annularly disposed at the main body.

9. The projector according to claim 7, wherein the wavelength conversion device further comprises a weighting material disposed on the annular body, the annular body has a first slot structure located between the weighting material and the wavelength conversion element.

10. The projector according to claim 7, wherein the wavelength conversion device further comprises:
a drive motor, having a rotating axis and a second joint surface, wherein the second joint surface and the second surface of the substrate are jointed, and the wavelength conversion element and the annular body are adapted to rotate around the rotating axis; and
a third adhesive layer, disposed between the second joint surface and the second surface, wherein the drive motor is adhered to the wavelength conversion element through the third adhesive layer.

11. The projector according to claim 7, wherein the wavelength conversion element has a second slot structure disposed on the substrate, wherein the second slot structure is located between the annular body and the at least one wavelength conversion region and also between the weighting structure and the at least one wavelength conversion region.

12. The projector according to claim 1, wherein the substrate of the wavelength conversion element has a first inner wall surface and a second inner wall surface, the first inner wall surface and the second inner wall surface are adjacent to the through slot and face each other, an angle is formed between the first inner wall surface and the second inner wall surface, wherein the weighting structure is connected to a first position of the through slot when the angle is a first angle, the weighting structure is connected to a second position of the through slot when the angle is a second angle, and a distance between the first position and a center point of the wavelength conversion element is smaller than a distance between the second position and the center point of the wavelength conversion element when the first angle is smaller than the second angle.

13. The projector according to claim 1, wherein the weighting structure is connected to a first position of the through slot when a density of the weighting structure has a first density value, the weighting structure is connected to a second position of the through slot when the density of the weighting structure has a second density value, and a distance between the first position and a center point of the wavelength conversion element is smaller than a distance between the second position and the center point of the wavelength conversion element when the first density value is greater than the second density value.

14. A wavelength conversion device, comprising:
a wavelength conversion element, having a substrate, at least one wavelength conversion region, and a through slot, wherein the at least one wavelength conversion region is disposed on the substrate;
a light transmissive element, disposed at the through slot to form a light transmissive region adjacent to the at least one wavelength conversion region; and
a weighting structure, connected to the substrate, and having a first joint surface, wherein the first joint surface of the weighting structure and the light transmissive element are jointed.

15. The wavelength conversion device according to claim 14, wherein the substrate of the wavelength conversion element has a first surface, a second surface opposite to the first surface, and an inner wall surface adjacent to the through slot, the at least one wavelength conversion region is disposed on the first surface, the weighting structure is disposed on the second surface, the first joint surface faces the through slot, the inner wall surface is disposed between the first surface and the first joint surface, and the light transmissive element leans against the inner wall surface.

16. The wavelength conversion device according to claim 14, wherein the substrate of the wavelength conversion element has a first surface, a second surface opposite to the first surface, and an inner wall surface adjacent to the through slot, the at least one wavelength conversion region is disposed on the first surface, the weighting structure is disposed on the first surface, the first joint surface faces the through slot, the inner wall surface is disposed between the second surface and the first joint surface, and the light transmissive element leans against the inner wall surface.

17. The wavelength conversion device according to claim 14, wherein the substrate of the wavelength conversion element has a first surface and a second surface opposite to the first surface, the at least one wavelength conversion region is disposed on the first surface, the weighting structure has a third surface opposite to the first joint surface, the first joint surface and the first surface are coplanar, and the third surface and the second surface are coplanar.

18. The wavelength conversion device according to claim 14, wherein the substrate of the wavelength conversion element has a first surface and a second surface opposite to the first surface, the at least one wavelength conversion region is disposed on the first surface, the weighting structure has a third surface opposite to the first joint surface, the first joint surface and the second surface are coplanar, and the third surface and the first surface are coplanar.

19. The wavelength conversion device according to claim 14, further comprising a first adhesive layer disposed between the weighting structure and the light transmissive element, wherein the light transmissive element is adhered to the weighting structure through the first adhesive layer.

20. The wavelength conversion device according to claim 14, wherein the substrate of the wavelength conversion element has a first surface and a second surface opposite to the first surface, the at least one wavelength conversion region is disposed on the first surface, the wavelength conversion device further comprises:
an annular body, disposed on the first surface, wherein a part of the light transmissive element is covered by the annular body; and
a second adhesive layer, disposed between the annular body and the wavelength conversion element, and disposed between the annular body and the light transmissive element, wherein the annular body is adhered to the wavelength conversion element and the light transmissive element through the second adhesive layer.

21. The wavelength conversion device according to claim 20, wherein the annular body has a main body and a first slot structure, wherein the first slot structure is annularly disposed at the main body.

22. The wavelength conversion device according to claim 20, further comprising a weighting material disposed on the annular body, the annular body has a first slot structure located between the weighting material and the wavelength conversion element.

23. The wavelength conversion device according to claim 20, further comprising:
a drive motor, having a rotating axis and a second joint surface, wherein the second joint surface and the second surface of the substrate are jointed, and the wavelength conversion element and the annular body are adapted to rotate around the rotating axis; and
a third adhesive layer, disposed between the second joint surface and the second surface, wherein the drive motor is adhered to the wavelength conversion element through the third adhesive layer.

24. The wavelength conversion device according to claim 20, wherein the wavelength conversion element has a second slot structure disposed on the substrate, wherein the second slot structure is located between the annular body and the at least one wavelength conversion region and also between the weighting structure and the at least one wavelength conversion region.

25. The wavelength conversion device according to claim 14, wherein the substrate of the wavelength conversion element has a first inner wall surface and a second inner wall surface, the first inner wall surface and the second inner wall surface are adjacent to the through slot and face each other, an angle is formed between the first inner wall surface and the second inner wall surface, wherein the weighting structure is connected to a first position of the through slot when the angle is a first angle, the weighting structure is connected to a second position of the through slot when the angle is a second angle, and a distance between the first position and a center point of the wavelength conversion element is smaller than a distance between the second position and the center point of the wavelength conversion element when the first angle is smaller than the second angle.

26. The wavelength conversion device according to claim 14, wherein the weighting structure is connected to a first position of the through slot when a density of the weighting structure has a first density value, the weighting structure is connected to a second position of the through slot when the density of the weighting structure has a second density value, and a distance between the first position and a center point of the wavelength conversion element is smaller than a distance between the second position and the center point of the wavelength conversion element when the first density value is greater than the second density value.
